(19) United States
(12) Patent Application Publication
(10) Pub. No.: US 2025/0307603 A1
(43) Pub. Date: Oct. 2, 2025

(54) NEURAL NETWORKS WITH REGULARIZED ATTENTION LAYERS

(71) Applicant: DeepMind Technologies Limited, London (GB)

(72) Inventors: Bobby Boyi He, Oxford (GB); James Martens, London (GB)

(21) Appl. No.: 18/872,883

(22) PCT Filed: Sep. 27, 2023
(86) PCT No.: PCT/EP2023/076794

§ 371 Date: Dec. 9, 2024

Related U.S. Application Data
(60) Provisional application No. 63/411,007, filed on Sep. 28, 2022.

(51) Int. Cl. G06N 3/045; G06N 3/08

(52) U.S. Cl. CPC G06N 3/045; G06N 3/08

(57) ABSTRACT

Methods, systems, and apparatus, including computer programs encoded on a computer storage medium, for processing a network input using a neural network that includes one or more regularized attention layers. In one aspect, a method comprises: receiving a layer input to a regularized attention layer, wherein the layer input to the regularized attention layer comprises a set of input embeddings; and applying a regularized attention operation over the set of input embeddings to generate a set of output embeddings, comprising: transforming intermediate attention scores using a set of shaping constants to generate a set of transformed attention scores, wherein: values of the shaping constants are initialized prior to training of the neural network and are not adjusted during the training of the neural network; and the values of the shaping constants are selected to regularize the set of output embeddings.

### CROSS-REFERENCE TO RELATED APPLICATION

This application claims priority to U.S. Provisional Application No. 63/411,007, filed on Sep. 28, 2022. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that processes an input using a neural network that includes one or more regularized attention layers to generate a network output.

Throughout this specification, an “embedding” can refer to an ordered collection of numerical values, e.g., a vector, matrix, or other tensor of numerical values.

Throughout this specification, the “rank” of a matrix can refer to the dimension of the vector space generated by the columns (or rows) of the matrix. For instance, a matrix with rank equal to one (i.e., a “rank-1” matrix) is a matrix with columns (or rows) that generate a one-dimensional vector space, e.g., such that each column (or row) is a scalar multiple of each other column (or row). Similarly, the rank of a set of embeddings can refer to the dimension of the vector space generated by the set of embeddings.

Throughout this specification, “regularizing” data generated by a neural network (e.g., data generated by one or more layers of the neural network) can refer to modifying the data in order to reduce or prevent numerical issues during training or inference. For instance, regularizing data generated by a neural network can include one or more of: (i) modifying the data to maintain or reduce a norm of the data (or of portions of the data), (ii) modifying the data to maintain or increase a norm of gradients of an objective function that is used for training the neural network, or (iii) modifying the data to maintain or increase a rank of the data.

According to one aspect, there is provided a method performed by one or more computers, the method comprising: receiving a network input; processing the network input using a neural network that comprises a plurality of neural network layers arranged as a directed graph to generate a network output for the network input, wherein the plurality of neural network layers comprise one or more regularized attention layers, and wherein processing the network input comprises, for each regularized attention layer: receiving a layer input to the regularized attention layer, wherein the layer input to the regularized attention layer comprises a set of input embeddings; and applying a regularized attention operation over the set of input embeddings to generate a set of output embeddings, comprising: processing the set of input embeddings, in accordance with values of a set of regularized attention layer parameters, to generate: (i) a set of value embeddings, comprising a respective value embedding for each input embedding, and (ii) a set of intermediate attention scores; transforming the intermediate attention scores using a set of shaping constants to generate a set of transformed attention scores, wherein: values of the shaping constants are initialized prior to training of the neural network and are not adjusted during the training of the neural network; and the values of the shaping constants are selected to regularize the set of output embeddings; and generating the set of output embeddings using: (i) the set of value embeddings, and (ii) the set of transformed attention scores; and providing a layer output for the attention layer based on the set of output embeddings.

In some implementations, the values of the shaping constants are selected to maintain or increase a rank of the set of output embeddings.

In some implementations, the values of the shaping constants are selected to increase a likelihood that the rank of the set of output embeddings exceeds a threshold.

In some implementations, the values of the set of shaping constants are derived from a shaping matrix by operations comprising: determining a decomposition of the shaping matrix into a product of: (i) a diagonal matrix, and (ii) a partition matrix, wherein the partition matrix has row sums equal to one; and applying a logarithm to the partition matrix, the shaping matrix being based on the result of applying the logarithm to the partition matrix.

In some implementations, the shaping matrix is derived from at least one base matrix, wherein values of off-diagonal entries of the base matrix decay exponentially based on a distance from a diagonal of the base matrix.

In some implementations, each on-diagonal entry of the base matrix has a same value.

In some implementations, each of the on-diagonal entries of the base matrix have value one.

In some implementations, the shaping matrix is derived from at least one base matrix, wherein diagonal entries of the base matrix each have a same first value and off-diagonal entries of the base matrix each have a same second value.

In some implementations, the first value is one and the second value is strictly less than one.

In some implementations, transforming the intermediate attention scores using the set of shaping constants to generate the set of transformed attention scores comprises, for each intermediate attention score: generating a corresponding transformed attention score by combining the intermediate attention score with a corresponding shaping constant.

In some implementations, for each intermediate attention score, generating the corresponding transformed attention score comprises: summing the intermediate attention score with the corresponding shaping constant.

In some implementations, processing the set of input embeddings to generate the set of intermediate attention scores comprises: processing the set of input embeddings to generate: (i) a respective query embedding, and (ii) a respective key embedding, for each input embedding; and generating each intermediate attention score based on a measure of similarity between a corresponding query embedding and a corresponding key embedding.

In some implementations, generating the set of output embeddings using: (i) the set of value embeddings, and (ii) the set of transformed attention scores, comprises: generating a set of final attention scores by applying a causal masking operation followed by a non-linear transformation to the set of transformed attention scores; and generating the set of output embeddings using: (i) the set of value embeddings, and (ii) the set of transformed attention scores.

In some implementations, the non-linear transformation is a soft-max transformation.

In some implementations, generating the set of output embeddings using: (i) the set of value embeddings, and (ii) the set of transformed attention scores, comprises: generating each output embedding based on a linear combination of the set of value embeddings, wherein coefficients of the linear combination are defined by respective transformed attention scores from the set of transformed attention scores.

In some implementations, generating the set of output embeddings comprises: applying an embedding-specific rescaling to the set output embeddings based on the diagonal matrix.

In some implementations, prior to training of the neural network, the values of the regularized attention layer parameters are initialized to cause a value of each of the intermediate attention scores to be zero.

In some implementations, prior to training of the neural network, the values of the regularized attention layer parameters are initialized to encourage a value of each of the intermediate attention scores to be near zero.

In some implementations, prior to training of the neural network, the values of selected regularized attention layer parameters are: (i) initialized to zero, or (ii) selected from within a tolerance range around zero, or (iii) sampled from a probability distribution having a standard deviation selected from within a tolerance range around zero.

In some implementations, the neural network comprises a plurality of regularized attention layers that are associated with an ordering, wherein each of the plurality of regularized attention layers are associated with a different set of shaping constants.

In some implementations, the neural network is configured to autoregressively generate a sequence of outputs.

In some implementations, the neural network does not include skip connections associated with the regularized attention layers in the neural network.

In some implementations, the neural network does not include normalization layers associated with the regularized attention layers in the neural network.

In some implementations, regularizing the set of output embeddings comprises one or more of: (i) modifying the set of output embeddings to maintain or reduce a norm of output embeddings included in the set of output embeddings, (ii) modifying the set of output embeddings to maintain or increase a norm of gradients of an objective function that is used for training the neural network, or (iii) modifying the set of output embeddings to maintain or increase a rank of the set of output embeddings.

According to another aspect, there is provided a system comprising: one or more computers; and one or more storage devices communicatively coupled to the one or more computers, wherein the one or more storage devices store instructions that, when executed by the one or more computers, cause the one or more computers to perform operations of the methods described herein.

One or more non-transitory computer storage media storing instructions that when executed by one or more computers cause the one or more computers to perform operations of the methods described herein.

Particular embodiments of the subject matter described in this specification can be implemented so as to realize one or more of the following advantages.

Many deep neural networks that include attention layers are difficult to train quickly and fail to generalize well to unseen data after training. For example, many tasks require that the neural network have very specific architectural elements, e.g., skip connections, normalization layers, and so on, in order to be trained to perform well on the task. However, the requirement for including these specific architectural elements can mask hidden issues in neural network architectures, can make it difficult to design new neural network architectures and, more generally, can make it difficult to train neural networks that do not have these elements but might otherwise exhibit improved performance on these tasks. This specification describes techniques for modifying attention layers of neural networks to eliminate the requirement for these elements and to allow neural networks to be trained effectively and quickly even when these elements are not included. Moreover, applying the described techniques results in neural networks that generalize better to unseen data after training, resulting in improved inference performance. As a particular example, a neural network that otherwise could not have been trained in a reasonable amount of time or with a reasonable amount of compute because it lacks one or more specific elements, e.g., skip connections or batch normalization, can instead be trained to exceed the performance of a conventional neural network that does have the specific elements (if the neural network being trained includes the described regularized attention layers).

During training, neural networks that include attention layers can suffer from regularization issues such as “rank collapse,” a condition where the rank of the set of embeddings operated on by the attention layers reduces to a small value, e.g., one, two, or three. For instance, rank collapse can occur if each embedding in the set of embeddings operated on by the attention layers become (approximately or exactly) aligned in the same direction. Rank collapse can significantly hinder the training of a neural network, e.g., by zeroing the gradients for certain parameters in the attention layers. Conventionally, regularization issues such as rank collapse are addressed using architectural elements such as skip connections and normalization layers, as described above. This specification describes techniques for modifying the attention operations performed by an attention layer in a manner that can reduce the likelihood of regularization issues without requiring the use of skip connections and normalization layers.

The techniques described in this specification can reduce usage of computational resources (e.g., memory and computing power) by a neural network by obviating the need to include architectural elements such as skip connections and normalization layers in the neural network. For instance, implementing a skip connection that “skips” a block in a neural network can require storing the input to the block while generating the output of the block, e.g., to enable the block input to be combined with (e.g., added to) the block output. Removing skip connections from a neural network thus reduces the memory footprint of the neural network by reducing temporary storage of intermediate outputs. Implementing a normalization layer can require performing computationally intensive operations by aggregating data to generate normalization constants, and removing normalization layers thus eliminates part of the computational footprint of the neural network. By reducing usage of computational resources (as described above), the techniques described in this specification can enable certain neural networks to be implemented on a single target device rather than being implemented in a distributed fashion, e.g., across multiple devices.

In particular, neural networks with attention layers (e.g., large-scale transformer neural networks) are often deployed on hardware accelerators (e.g., graphics processing units, GPUs) that have limited on-chip memory. However, as described above, such neural networks often have significant memory requirements that may exceed the memory available on hardware accelerators, e.g., because of the inclusion of skip connections and normalization layers. The neural network described in this specification can have lower memory requirements, e.g., by obviating the need for skip connections and normalization layers through the use of regularized attention operations, and can thus be implemented more readily on hardware accelerators. Further, the neural network described in this specification can reduce requirements for memory bandwidth, e.g., writing/reading data to/from disk during training and inference, thus further reducing consumption of computational resources.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a flow diagram of an example process for processing a layer input, by a regularized attention layer, to generate a layer output.

FIG. 3 is a flow diagram of an example process for generating a set of shaping constants for conditioning a regularized attention layer of a neural network.

FIG. 4 is a flow diagram of an example process for training a neural network that includes one or more regularized attention layers.

FIG. 5 illustrates the evolution of normalized kernel matrices of attention layers in neural networks.

FIG. 6 shows the training loss over a sequence of training steps for various possible neural network architectures.

FIG. 7 shows the sensitivity of the training performance of a neural network with regularized attention layers to the initial values of certain parameters of the regularized attention layers.

Like reference numbers and designations in the various drawings indicate like elements.

### DETAILED DESCRIPTION

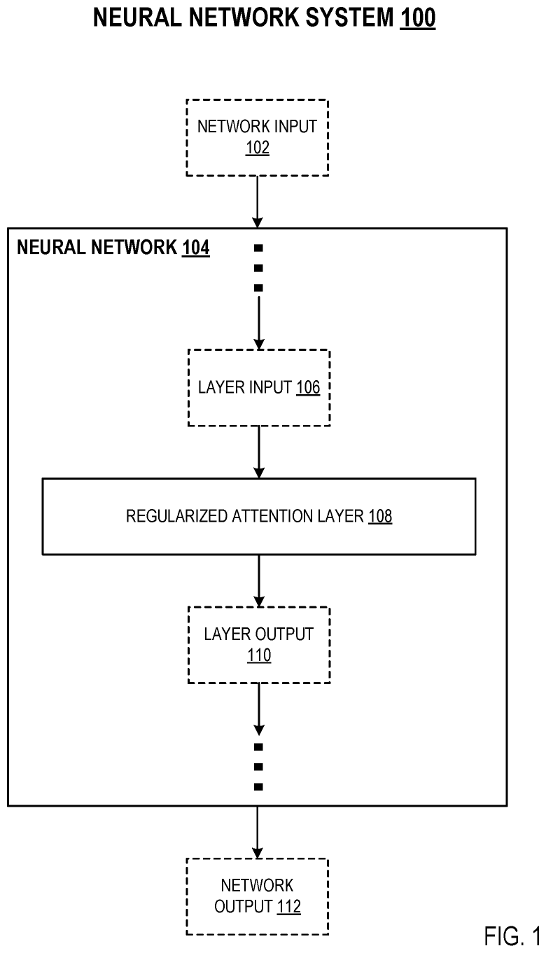

FIG. 1 shows an example neural network system 100. The neural network system 100 is an example of a system implemented as computer programs on one or more computers in one or more locations in which the systems, components, and techniques described below are implemented.

The neural network system 100 includes a neural network 104 that is configured to process a network input 102, in accordance with values of a set neural network parameters of the neural network 104, to generate a corresponding network output. The neural network 104 includes one or more regularized attention layers 108 that perform attention operations which are conditioned on a set of “shaping constants.” The values of the shaping constants are selected to regularize the network outputs of the regularized attention layers, e.g., to reduce a likelihood of regularization issues such as rank collapse among sets of output embeddings generated by the regularized attention layers, as will be described in more detail below.

The neural network 104 can be configured to perform any appropriate neural network task, and in particular, can be configured to process any appropriate network input to generate any appropriate network output. A few examples of neural network tasks that can be performed by the neural network 104 are described next.

In some implementations, the neural network can be configured to receive an input image and to process the input image to generate a network output for the input image, i.e., to perform an image processing task. In this specification, processing an input image refers to processing the intensity values of the pixels of the image using a neural network. The image can be, e.g., an image captured by a camera, a point cloud image captured by a lidar or other laser sensor, a hyperspectral image, a medical image captured by a medical imaging device, or any other appropriate type of data that can be represented in an image format.

For example, the task may be image classification and the output generated by the neural network for a given image may be scores for each of a set of object categories, with each score representing an estimated likelihood that the image contains an image of an object belonging to the category.

As another example, the task can be image embedding generation and the output generated by the neural network can be a numeric embedding of the input image.

As yet another example, the task can be object detection and the output generated by the neural network can identify locations in the input image, e.g., bounding boxes or other geometric regions within the image, at which particular types of objects are depicted.

As yet another example, the task can be image segmentation and the output generated by the neural network can define for each pixel of the input image which of multiple categories the pixel belongs to.

In some implementations, the inputs to the neural network are Internet resources (e.g., web pages), documents, or portions of documents or features extracted from Internet resources, documents, or portions of documents, and the neural network performs the task of classifying the resource or document. For instance, the output generated by the neural network for a given Internet resource, document, or portion of a document may be a score for each of a set of topics, with each score representing an estimated likelihood that the Internet resource, document, or document portion is about the topic.

In some implementations, the inputs to the neural network are features of an impression context for a particular advertisement, and the output generated by the neural network may be a score that represents an estimated likelihood that the particular advertisement will be clicked on.

In some implementations, the inputs to the neural network are features of a personalized recommendation for a user, e.g., features characterizing the context for the recommendation, e.g., features characterizing previous actions taken by the user, and the output generated by the neural network may be a score for each of a set of content items, with each score representing an estimated likelihood that the user will respond favorably to being recommended the content item.

In some implementations, the input to the neural network is a sequence of text in one language, and the output generated by the neural network may be a score for each of a set of pieces of text in another language, with each score representing an estimated likelihood that the piece of text in the other language is a proper translation of the input text into the other language.

In some implementations, the neural network can perform an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, the task may be a keyword spotting task where, where the input to the neural network is a sequence representing a spoken utterance, the output generated by the neural network can indicate whether a particular word or phrase (“hotword”) was spoken in the utterance. As another example, the input to the neural network can be a sequence representing a spoken utterance, and the output generated by the neural network can identify the natural language in which the utterance was spoken.

In some implementations, the neural network can perform a natural language processing or understanding task, e.g., an entailment task, a paraphrase task, a textual similarity task, a sentiment task, a sentence completion task, a grammaticality task, and so on, that operates on a sequence of text in some natural language.

In some implementations, the neural network can perform a text to speech task, where the input is text in a natural language or features of text in a natural language and the network output is a spectrogram or other data defining audio of the text being spoken in the natural language.

In some implementations, the neural network can perform a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some implementations, the neural network can be configured to generate a network output autoregressively. That is, the neural network can be configured to generate a network output that includes a respective output element at each position in a sequence of output positions. The neural network can generate the output elements one at a time, in accordance with the ordering of the positions in the output sequence. For each position, the neural network can generate the output element at the position based on output elements at preceding positions in the output sequence, but not based on output elements at future positions in the output sequence (i.e., which have not yet been generated). For instance, the neural network can autoregressively generate pixel values in an image, or audio samples in an audio waveform, or characters in a sequence of text, etc.

In some implementations, the neural network can perform a combination of multiple individual machine learning tasks, i.e., the neural network is configured to perform multiple different individual machine learning tasks, e.g., two or more of the machine learning tasks mentioned above. For example, the neural network can be configured to perform multiple individual natural language understanding tasks. Optionally, the network input can include an identifier for the individual task to be performed on the network input. As another example, the neural network can be configured to perform multiple individual image processing or computer vision tasks, i.e., by generating the output for the multiple different individual image processing tasks in parallel by processing a single input image.

In some implementations, the neural network can perform an agent control task, where the input is an observation characterizing the state of an environment and the output defines an action to be performed by the agent in response to the observation. For instance, the output can define a score distribution over a set of possible actions that can be performed by the agent, and the action to be performed by the agent can be selected using the score distribution.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use of a resource, the metric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutical drug and the agent is a computer system for determining elements of the pharmaceutical drug and/or a synthetic pathway for the pharmaceutical drug. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources e.g. on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards or return may comprise one or more metrics of performance of the design of the entity. For example rewards or returns may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus a design of an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions of an agent in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

The neural network 104 can be implemented in any appropriate location, e.g., on a user device, on agent (e.g., a mechanical agent, e.g., a robot or a vehicle), or in a data center, or in a cloud environment. In some cases, the neural network 104 can implemented in a distributed fashion across two or more locations. For instance, a first subnetwork of the neural network 104 can be implemented on a user device or on an agent while a second subnetwork of the neural network 104 can be implemented in a data center or cloud environment.

The neural network 104 can have any appropriate neural network architecture that enables the neural network to perform its described functions, e.g., processing a network input to generate a corresponding network output as part of performing a neural network task. For instance, the neural network 104 can include any appropriate types of neural network layers (e.g., fully-connected layers, convolutional layers, attention layers, etc.) in any appropriate numbers (e.g., 5, 50, or 100 layers) and connected in any appropriate configuration (e.g., as a directed graph of layers).

The neural network 104 includes one or more regularized attention layers 108. In particular, the neural network 104 can include any appropriate number of regularized attention layers 108, e.g., 1, 5, 10, or 100 regularized attention layers, and the regularized attention layers can, optionally, be interleaved with other neural network layers. Optionally, the architecture of the neural network 104 can exclude normalization layers, or skip connections, or both. The regularized attention layers of the neural network 104 can enable stable training and inference performance of the neural network 104 even without normalization layers and skip connections, and even when the neural network is a deep neural network with many layers, e.g., 30, 50, or 100 layers.

Each regularized attention layer is configured to process a layer input 106 to the regularized attention layer 108 to generate a corresponding layer output 110 of the regularized attention layer. The layer input 106 can include a set of input embeddings, and the layer output 110 can include a set of output embeddings. The number of input embeddings can, in some cases, be equal to the number of output embeddings. The input embeddings and the output embeddings can have any appropriate dimensionality, and optionally, the input embeddings can have a different dimensionality than the output embeddings.

The neural network 104 can provide any appropriate layer input 106 to the regularized attention layer, e.g., a layer input that includes at least a portion of the layer output of another neural network layer, or a layer input that includes at least a portion of the network input 102, or both. Similarly, the neural network 104 can provide the layer output 110 of the regularized attention layer 108, e.g., for processing by another layer in the neural network 104, or as the network output 112 of the neural network 104.

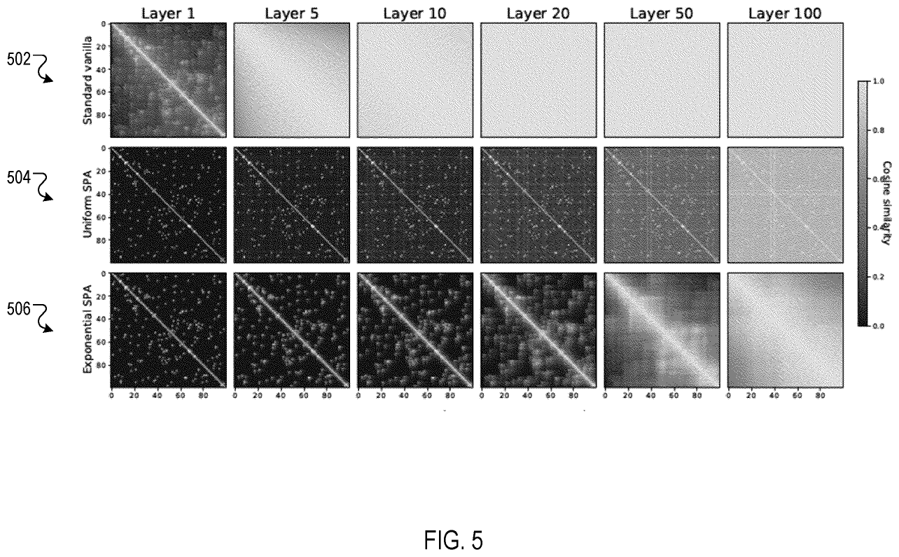

Signal propagation through a neural network can be assessed (at least in part) with reference to the evolution of “kernel matrices” through the layers of the neural network. The kernel matrix associated with a layer l of a neural network can be defined as:

$${\sum }_{l} = \frac{{X}_{l} {X}_{l}^{T}}{d} ∈ {ℝ}^{T \times T} \qquad ( 1 )$$

where Xₗ∈ [symbol] denotes a length-T sequence of activations at layer l, i.e., that is generated when the neural network processes a network input to generate a corresponding network output. Regularization issues can arise in neural networks, e.g., where the diagonal entries of the kernel matrices rapidly grow or shrink with depth, which can be indicative of uncontrolled activation norms and can lead to saturated losses or other numerical issues. Another form of regularization issue that can arise is rank collapse, e.g., where the rank of the kernel matrices converges to a small value, e.g., one, two, or three. Rank collapse may lead to zero gradients for certain neural network parameters and thus hinder the training of the neural network. Mitigating numerical issues such as rank collapse can be crucial for enabling effective training of a neural network. An illustration of the evolution of kernel matrices through the layers of a neural network is described with reference to FIG. 5, which will be described in more detail below.

Each regularized attention layer 108 is conditioned on (e.g., parameterized by) a respective set of shaping constants. The shaping constants have values that are initialized prior to the training of the neural network 104 and, optionally, are not adjusted during the training of the neural network. The values of the shaping constants for a regularized attention layer are selected to regularize the set of output embeddings generated by the regularized attention layer, e.g., to prevent rank collapse by increasing the likelihood that the rank of the set of output embeddings exceeds a threshold.

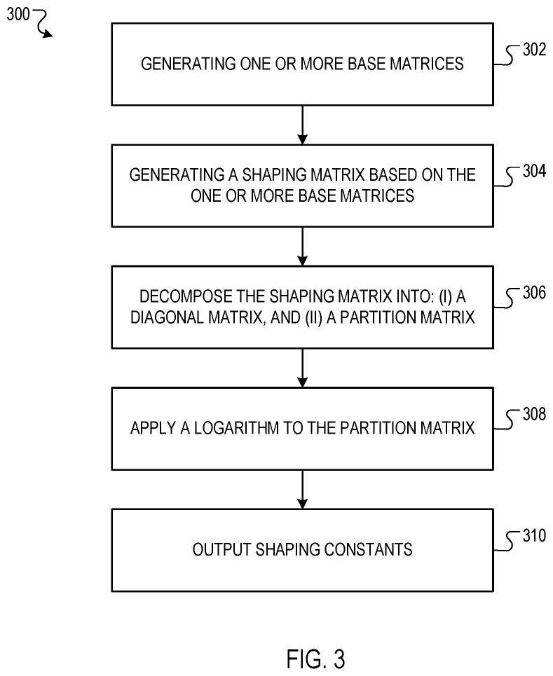

More specifically, each regularized attention layer 108 is configured to apply an attention operation to the set of input embeddings in the layer input 106 to the regularized attention layer 108 as part of generating the layer output 110 of the regularized attention layer. Applying an attention operation involves processing the layer input to generate a set of attention scores which, when represented in the form of a matrix, can be referred to as an attention matrix. The kernel matrix of a regularized attention layer can be characterized as a function of a product of the attention matrices generated by the preceding regularized attention layers. Thus, the evolution of the kernel matrices (which, as described above, characterize signal propagation through the neural network) depends on the properties of the products of attention matrices generated by the regularized attention layers. One approach for selecting shaping constants that have the effect of regularizing the outputs of attention layers is to identify shaping constants that increase the likelihood that the products of attention matrices generated by the attention layers have desirable numerical properties, e.g., full rank and bounded norms. An example process for generating such shaping constants is described in more detail below with reference to FIG. 3.

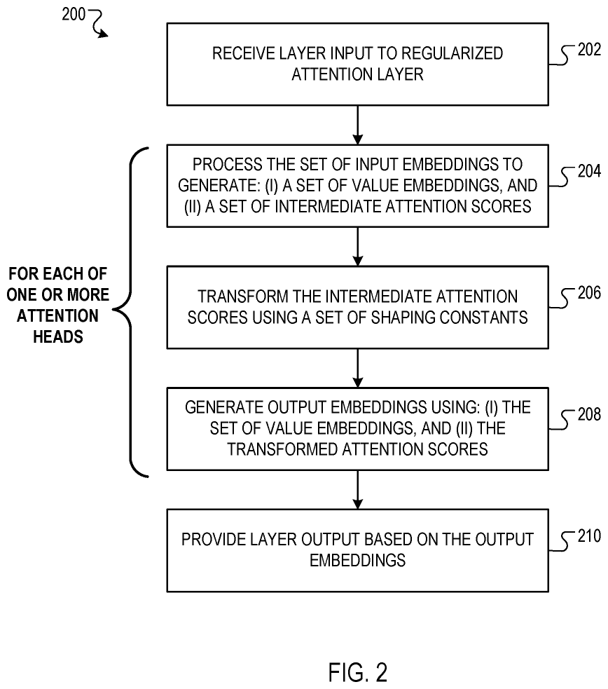

Next, an example process by which a regularized attention layer 108 can apply a regularized attention operation to a layer input to generate a layer output is described in more detail below with reference to FIG. 2.

FIG. 2 is a flow diagram of an example process 200 for processing a layer input, by a regularized attention layer, to generate a layer output. For convenience, the process 200 will be described as being performed by a system of one or more computers located in one or more locations. For example, a neural network system, e.g., the neural network system 100 of FIG. 1, appropriately programmed in accordance with this specification, can perform the process 200.

The system receives the layer input to the regularized attention layer (202). The layer input includes a set of input embeddings which can form the columns or rows of a matrix X∈ [symbol] , where T is the number of input embeddings and d is the dimensionality of each input embedding.

The system performs the operations of steps 204-208 for each of one or more attention heads of the regularized attention layer. The regularized attention layer can include any appropriate number of attention heads, e.g., 1, 5, or 10 attention heads. Each attention head of the regularized attention layer can have a respective set of attention head parameters that are specific to the attention head, and in particular, that are different from each of the other attention heads.

For each attention head, the system processes the set of input embeddings, in accordance with values of the set of parameters of the attention head, to generate: (i) a set of value embeddings (including a respective value embedding corresponding to each input embedding), and (ii) a set of intermediate attention scores (204).

The system can generate a matrix V∈ [symbol] with rows or columns representing the set of value embeddings, e.g., where T is the number of value embeddings, dₕ is the dimensionality of each value embedding, dₕ=d/h, d is the dimensionality of the input embeddings, and h is the number of attention heads), as:

$$V = X \cdot {W}^{V} \qquad ( 2 )$$

where X is the matrix representing the set of input embeddings and W^{V}∈ [symbol] is a matrix of (trainable) parameter values of the regularized attention layer.

The system can generate a matrix A∈ [symbol] of intermediate attention scores as:

$$A = \frac{Q ( X ) \cdot {K ( X )}^{T}}{\sqrt{{d}_{h}}} \qquad ( 3 )$$

$$Q ( X ) = X \cdot {W}^{Q} \qquad ( 4 )$$

$$K ( X ) = X \cdot {W}^{K} \qquad ( 5 )$$

where Q(X)∈ [symbol] is a matrix of query embeddings, K(X)∈ [symbol] is a matrix of key embeddings, and W^{Q}, W^{K} are matrices of (trainable) parameter values of the regularized attention layer.

In some cases, e.g., for an autoregressive neural network that generates a sequence of output tokens one at a time, some of the intermediate attention scores (e.g., those involving attention between previously produced tokens) may be precomputed and stored, such that the neural network does not regenerate these attention scores but rather retrieves them from a cache.

For each attention head, the system transforms the intermediate attention scores generated by the attention head using a set of shaping constants to generate a set of transformed attention scores (206). The values of the shaping constants are initialized prior to the training of the neural network, and optionally, are not adjusted during the training of the neural network. The values of the shaping constants are selected to regularize the set of output embeddings generated by the regularized attention layer. Each attention head of the regularized attention layer can optionally use the same shaping constants, i.e., shaping constants having the same values as those used by each other attention head of the regularized attention layer.

In some implementations, the system generates the set of transformed attention scores A′∈ [symbol] as:

$${A}^{′} = A + B \qquad ( 6 )$$

where A is a matrix of intermediate attention scores and B is a matrix of shaping constants. An example process for generating the matrix of shaping constants B is described in more detail with reference to FIG. 3. The matrix of shaping constants B can be derived from “base matrices” having diagonals equal to one (as will be described in more detail with reference to FIG. 3), which causes the shaping constants to provide an implicit mechanism to control output embedding norms across all sequence locations at deep layers. Further, the matrix of shaping constants B can cause a “recency bias,” where output embeddings are nearby locations have larger cosine similarity.

In some implementations, the system generates the set of transformed attention scores A′∈ [symbol] as:

$${A}^{′} = α I + β A \qquad ( 7 )$$

where α, β are trainable (scalar) parameters, I denotes an identity matrix (i.e., a square matrix with ones on the diagonal and zeros off the diagonal), and A is a matrix of intermediate attention scores. In this example, the shaping constants are the binary entries of the identity matrix I. The shaping constants expressed in equation (7) can regularize the output embeddings, e.g., by preventing rank collapse, but may not achieve all of the advantages of the shaping constants expressed in equation (6). For instance, there may be useful information contained in certain sequence locations that is not employed when, at initialization, the intermediate attention scores are zero (or near zero) and the shaping constants (in this case, defined as a scaled identity matrix) control the attention operations.

Optionally, the system can further transform the intermediate attention scores through one or more additional modifications, i.e., in addition to transforming the intermediate attention scores using the shaping constants. For instance, the system can bias each attention score by a penalty based on a distance between the pair of input embeddings (i.e., from the layer input) that correspond to the attention score.

For each attention head, the system generates a set of output embeddings of the attention head using: (i) the set of value embeddings generated by the attention head, and (ii) the transformed attention scores generated by the attention head (208).

In some implementations, the system generates the set of output embeddings O∈ [symbol] of the attention head as:

$$O = {A}^{′} V \qquad ( 8 )$$

where A′ denotes the matrix of transformed attention scores and V denotes the matrix of value embeddings.

In some implementations, the system generates the set of output embeddings O∈ [symbol] of the attention head as:

$$O = D \cdot softmax ( M ∘ {A}^{′} - Γ ( 1 - M ) ) V \qquad ( 9 )$$

where the matrix D∈ [symbol] implements an embedding-specific rescaling to the set of output embeddings, softmax(·) denotes a softmax operator, M∈ [symbol] is a masking matrix satisfying M_{i,j}=1{i≥j} and zero otherwise, I is a large constant, e.g., 10³⁰, and V denotes the matrix of value embeddings. The masking matrix (and the associated large constant I) enforces causal masking of the attention scores (i.e. it applies a causal masking operation which, considering the input embeddings as being in a sequence (having an order corresponding to the order of the successive columns or rows of X), prevents a given output embedding, corresponding to a respective input embedding in the sequence, from being generated based on transformed attention scores for input embeddings of the sequence which are later than the input embedding corresponding to the given output embedding) and may be beneficial, e.g., if the neural network is configured to autoregressively generate a sequence of outputs. An example process for generating the matrix D that parametrizes the embedding-specific rescaling operation is described with reference to FIG. 3.

The system provides a layer output for the regularized attention layer based on the respective set of output embeddings generated by each attention head (210). For instance, the system can generate the layer output O′∈ [symbol] as:

$${O}^{′} = concat ( {O}_{1} , … , {O}_{h} ) {W}^{o} \qquad ( 10 )$$

where concat(·) is a concatenation operator, {Oᵢ}ᵢ₌₁^{h} are the respective output embeddings generated by each attention head, and W^{O} denotes a matrix of (trainable) parameter values of the regularized attention layer.

FIG. 3 is a flow diagram of an example process 300 for generating a set of shaping constants for conditioning a regularized attention layer of a neural network. The shaping constants generated by the process described in FIG. 3 can regularize output embeddings generated by the regularized attention layer. For convenience, the process 300 will be described as being performed by a system of one or more computers located in one or more locations. For example, a neural network system, e.g., the neural network system 100 of FIG. 1, appropriately programmed in accordance with this specification, can perform the process 300.

The system generates one or more “base” matrices (302). A few examples of possible base matrices are described next.

In some implementations, the system generates one or more base matrices where the values of the off-diagonal entries of the base matrix decay exponentially based on a distance from the diagonal of the base matrix. The on-diagonal entries of the base matrix can have the same value, e.g., the value one. For instance, the system can generate a first base matrix Σⁱⁿ∈ [symbol] and a second base matrix Σ^{out}∈ [symbol] , where:

$${( {\sum }^{i n} )}_{i , j} = exp ( - {γ}_{i n} \vert i - j \vert ) \qquad ( 11 )$$

$${( {\sum }^{out} )}_{i , j} = exp ( - {γ}_{out} \vert i - j \vert ) \qquad ( 12 )$$

where γᵢₙ and γₒᵤₜ are positive exponential decay rates with γᵢₙ≥γₒᵤₜ. In cases where the neural network includes a sequence of L>1 regularized attention layers, the system can instantiate a decreasing sequence of exponential decay rates {γₗ}ₗ₌₀^{L}, where γₗ≥γₗ₊₁, and where for each layer l, γᵢₙ for layer l can be selected as γₗ₋₁ and γₒᵤₜ for layer l can be selected as γₗ.

In some implementations, the system generates one or more base matrices where the diagonal entries of each base matrix each have a first value (e.g., the value one) and the non-diagonal entries of each base matrix each have a second value (e.g., a value strictly less than one). For instance, the system can generate a first base matrix Σⁱⁿ∈ [symbol] and a second base matrix Σ^{out}∈ [symbol] , where:

$${\sum }^{i n} = ( 1 - {ρ}_{i n} ) {I}_{T} + {ρ}_{i n} 1 {1}^{T} \qquad ( 13 )$$

$${\sum }^{out} = ( 1 - {ρ}_{out} ) {I}_{T} + {ρ}_{out} 1 {1}^{T} \qquad ( 14 )$$

where ρᵢₙ and ρₒᵤₜ are positive values with ρₒᵤₜ>ρᵢₙ. In cases where the neural network includes a sequence of L>1 regularized attention layers, the system can instantiate an increasing sequence of values {ρₗ}ₗ₌₀^{L}, where ρₗ₊₁≥ρₗ, and where for each layer l, ρᵢₙ for layer l can be selected as ρₗ₋₁ and ρₒᵤₜ for layer l can be selected as ρₗ.

The system generates a shaping matrix based on the one or more base matrices (304). For instance, to generate the shaping matrix, the system can generate a decomposition (e.g., a Cholesky decomposition or a lower-upper (LU) decomposition) of a first base matrix into a set of first decomposed matrices, e.g., such that the first base matrix is equal to a product of the first decomposed matrices. The system can further generate a decomposition of a second base matrix into a set of second decomposed matrices, e.g., such that the second base matrix is equal to a product of the second decomposed matrices. The system can then generate the shaping matrix based on a product of: (i) a first decomposed matrix from the set of first decomposed matrices, and (ii) an inverse of a second decomposed matrix from the set of second decomposed matrices.

More specifically, in some implementations, the system can generate a shaping matrix S as:

$$S = {L}_{out} \cdot {L}_{i n}^{- 1} \qquad ( 15 )$$

where Lₒᵤₜ is a Cholesky decomposition of a base matrix Σ^{out}, e.g., as defined in equations (12) or (14), and Lᵢₙ is a Cholesky decomposition of a base matrix Σⁱⁿ, e.g., as defined in equations (11) or (13).

As another example implementation, the system can generate a shaping matrix S as:

$$S = {E}_{out}^{- \frac{1}{2}} {L}_{out} {L}_{i n} {E}_{i n}^{\frac{1}{2}} \qquad ( 16 )$$

$${E}_{out} = Diag ( {L}_{out} \cdot {\sum }_{0} \cdot {L}_{out}^{T} ) \qquad ( 17 )$$

$${E}_{i n} = Diag ( {L}_{i n} \cdot {\sum }_{0} \cdot {L}_{i n}^{T} ) \qquad ( 18 )$$

$${\sum }_{0} = ( 1 - r ) {I}_{T} + r 1 {1}^{T} \qquad ( 19 )$$

where r is a positive constant, Lₒᵤₜ is a Cholesky decomposition of a base matrix Σ^{out}, e.g., as defined in equations (12) or (14), and Lᵢₙ is a Cholesky decomposition of a base matrix Σⁱⁿ, e.g., as defined in equations (11) or (13).

The system generates a decomposition of the shaping matrix into a product of: (i) a diagonal matrix with positive diagonal entries, and (ii) a matrix which has row sums equal to one, and which is referred to here as a partition matrix (306).

The system applies an element-wise logarithm operation to the partition matrix (308).

The system outputs a set of shaping constants (310). For instance, the entries of the matrix resulting from applying the element-wise logarithm operation to the partition matrix can define the shaping constants. The diagonal matrix can parametrize an embedding-specific rescaling operation, e.g., as described with reference to equation (9) in the description of FIG. 2.

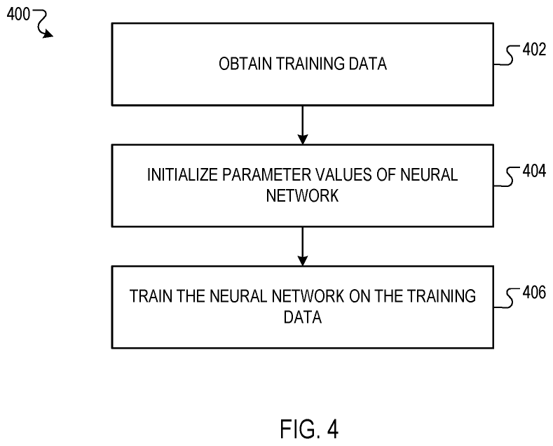

FIG. 4 is a flow diagram of an example process 400 for training a neural network that includes one or more regularized attention layers. For convenience, the process 400 will be described as being performed by a system of one or more computers located in one or more locations. For example, a neural network system, e.g., the neural network system 100 of FIG. 1, appropriately programmed in accordance with this specification, can perform the process 400.

The system obtains training data for training the neural network (402). The training data includes a set of training examples. In some cases, the set of training examples can include, e.g., labeled training examples that each include: (i) a training input to the neural network, and (ii) a target output that should be generated by the neural network by processing the training input. In some cases, the set of training examples can include, e.g., reinforcement learning training examples that each include: (i) a trajectory representing interaction of an agent with an environment over a sequence of one or more time steps, and (ii) data characterizing rewards generated during the trajectory.

The system initializes the values of the set of parameters of the neural network (404). In some cases, the system initializes the values of the set of parameters of the neural network such that processing a network input in accordance with the initialized values of the neural network parameters causes each regularized attention layer to generate intermediate attention scores having value zero (or values within a tolerance range around zero). For instance, the system can initialize the values of the parameters of the trainable weight matrix W^{Q} (as described with reference to equation (4)) to be zero (or within a tolerance range around zero, or sampled from a probability distribution with a mean of zero and with a standard deviation that is within a tolerance range around zero). As another example, the system can initialize the values of the parameters of the trainable weight matrix W^{K} (as described with reference to equation (5)) to be zero (or within a tolerance range around zero, or sampled from a probability distribution with a mean of zero and with a standard deviation that is within a tolerance range around zero).

Initializing the values of the neural network parameters to cause the intermediate attention scores to be initially zero (or near zero) causes the attention operations to be initially controlled by the values of the shaping constants. The values of the shaping constants are selected to regularize the outputs of the regularized attention layers, and the regularization can be particularly effective when the intermediate attention scores are zero (or near zero). During training, the values of the neural network parameters are iteratively adjusted such that the intermediate attention scores are no longer necessarily zero (or near zero). However, initializing the neural network in a mode of operation with strong regularization increases the likelihood that the benefits of regularization will persist throughout training and carry through into the trained neural network.

The remaining parameters of the neural network, e.g., that are not set in order to zero out the intermediate attention scores, can be initialized using any appropriate initialization scheme, e.g., glorot initialization or random initialization.

The system trains the neural network on the set of training data (406). The system can train the neural network, over a sequence of training iterations, in order to iteratively adjust the parameter values of the neural network to optimize an objective function. The objective function can be, e.g., a cross entropy objective function or a squared error objective function (e.g., if the neural network is being trained to perform a classification or regression task), or a reinforcement learning objective function (e.g., a Q-learning objective function, if the neural network is being trained to select actions for controlling an agent). At each training iteration, the system can determine gradients of the objective function with respect to the set of neural network parameters of the neural network, e.g., using backpropagation, and adjust the values of the set of neural network parameters using the gradients, e.g., in accordance with the update rule of an appropriate gradient descent optimization algorithm, e.g., RMSprop or Adam.

FIG. 5 illustrates the evolution of normalized kernel matrices of attention layers in neural networks. In particular, row 502 shows kernel matrices of layers 1, 5, 10, 20, 50, and 100 in a neural network with conventional attention layers that do not implement the regularized attention operations described in this specification. Rows 504 and 506 show kernel matrices of layers 1, 5, 20, 20, 50, and 100 in a neural network with two possible implementations of the regularized attention operations described in this specification. Using conventional attention layers, as shown in row 502, results in rank collapse where all entries of the normalized kernel converge to one. In contrast, using regularized attention layers as shown in rows 504 and 506, maintains controlled signal propagation even at large depths.

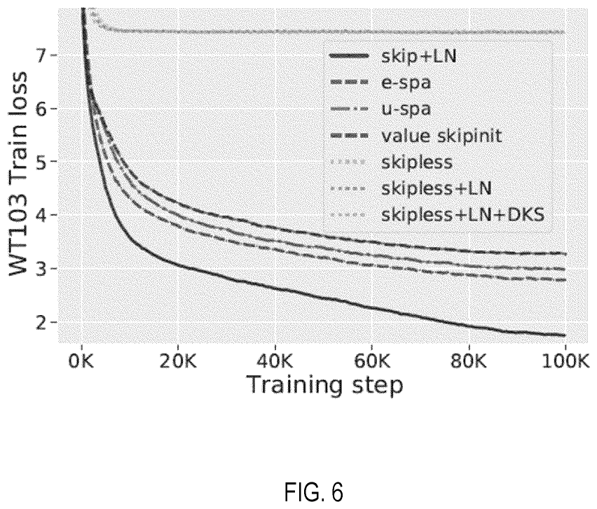

FIG. 6 shows the training loss over a sequence of training steps for various possible neural network architectures, including: (i) “e-spa”, “u-spa”, and “value skipinit”, which implement the regularized attention operations described in this specification, and (ii) other alternatives such as “skip+LN” (that implements skip connections and normalization layers), “skipless” (that does not implement any skip connections), “skipless+LN” (that implements normalization layers but not skip connections), and “skipless+LN+DKS” (that implements normalization layers and Deep Kernel Shaping but not skip connections). Regularizing the attention operations performed by the attention layers, using the techniques described in this specification, can allow a deep neural network with many attention layers to achieve acceptable performance (i.e. a training loss which is higher than that of skip+LN, but not unacceptably so) even without using skip connections or normalization layers.

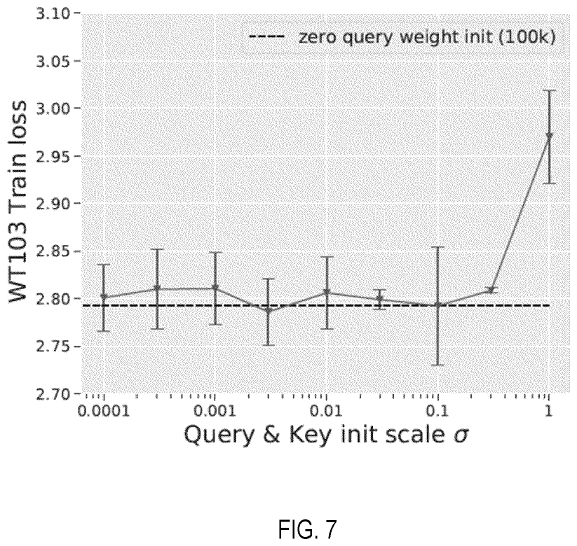

FIG. 7 shows the sensitivity of the training performance of a neural network with regularized attention layers to the magnitude of the initialization values of the trainable weight matrices W^{Q} (as described with reference to equation (4)) and W^{K} (as described with reference to equation (5)). Initializing the parameter values of the W^{Q} and/or W^{K} matrices to be zero (or near zero) can improve the performance of the neural network, as described with reference to FIG. 4. It will be appreciated from FIG. 7 that, as the initial parameter values of the W^{Q} and/or W^{K} deviate more significantly from zero (in particular, as a result of being sampled from probability distributions with higher standard deviations σ, particularly a standard deviation approaching one), the training loss increases.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a network input;
processing the network input using a neural network that comprises a plurality of neural network layers arranged as a directed graph to generate a network output for the network input,
wherein the plurality of neural network layers comprise one or more regularized attention layers, and
wherein processing the network input comprises, for each regularized attention layer:
receiving a layer input to the regularized attention layer, wherein the layer input to the regularized attention layer comprises a set of input embeddings; and
applying a regularized attention operation over the set of input embeddings to generate a set of output embeddings, comprising:
processing the set of input embeddings, in accordance with values of a set of regularized attention layer parameters, to generate: (i) a set of value embeddings, comprising a respective value embedding for each input embedding, and (ii) a set of intermediate attention scores;
transforming the intermediate attention scores using a set of shaping constants to generate a set of transformed attention scores, wherein:
values of the shaping constants are initialized prior to training of the neural network and are not adjusted during the training of the neural network; and
the values of the shaping constants are selected to regularize the set of output embeddings; and
generating the set of output embeddings using: (i) the set of value embeddings, and (ii) the set of transformed attention scores; and
providing a layer output for the attention layer based on the set of output embeddings.

2. The method of claim 1, wherein the values of the shaping constants are selected to maintain or increase a rank of the set of output embeddings.

3. The method of claim 2, wherein the values of the shaping constants are selected to increase a likelihood that the rank of the set of output embeddings exceeds a threshold.

4. The method of claim 1, wherein the values of the set of shaping constants are derived from a shaping matrix by operations comprising:
determining a decomposition of the shaping matrix into a product of: (i) a diagonal matrix, and (ii) a partition matrix, wherein the partition matrix has row sums equal to one; and
applying a logarithm to the partition matrix, the shaping matrix being based on the result of applying the logarithm to the partition matrix.

5. The method of claim 4, wherein the shaping matrix is derived from at least one base matrix, wherein values of off-diagonal entries of the base matrix decay exponentially based on a distance from a diagonal of the base matrix.

6. The method of claim 5, wherein each on-diagonal entry of the base matrix has a same value.

7. The method of claim 6, wherein each of the on-diagonal entries of the base matrix have value one.

8. The method of claim 4, wherein the shaping matrix is derived from at least one base matrix, wherein diagonal entries of the base matrix each have a same first value and off-diagonal entries of the base matrix each have a same second value.

9. The method of claim 8, wherein the first value is one and the second value is strictly less than one.

10. The method of claim 1, wherein transforming the intermediate attention scores using the set of shaping constants to generate the set of transformed attention scores comprises, for each intermediate attention score:
generating a corresponding transformed attention score by combining the intermediate attention score with a corresponding shaping constant.

11. The method of claim 10, wherein for each intermediate attention score, generating the corresponding transformed attention score comprises:
summing the intermediate attention score with the corresponding shaping constant.

12. The method of claim 4, wherein processing the set of input embeddings to generate the set of intermediate attention scores comprises:
processing the set of input embeddings to generate: (i) a respective query embedding, and (ii) a respective key embedding, for each input embedding; and
generating each intermediate attention score based on a measure of similarity between a corresponding query embedding and a corresponding key embedding.

13. The method of claim 4, wherein generating the set of output embeddings using: (i) the set of value embeddings, and (ii) the set of transformed attention scores, comprises:
generating a set of final attention scores by applying a causal masking operation followed by a non-linear transformation to the set of transformed attention scores; and
generating the set of output embeddings using: (i) the set of value embeddings, and (ii) the set of transformed attention scores.

14. The method of claim 13, wherein the non-linear transformation is a soft-max transformation.

15. The method of claim 13, wherein generating the set of output embeddings using: (i) the set of value embeddings, and (ii) the set of transformed attention scores, comprises:
generating each output embedding based on a linear combination of the set of value embeddings, wherein coefficients of the linear combination are defined by respective transformed attention scores from the set of transformed attention scores.

16. The method of claim 15, wherein generating the set of output embeddings comprises:
applying an embedding-specific rescaling to the set output embeddings based on the diagonal matrix.

17. The method of claim 1, wherein prior to training of the neural network, the values of the regularized attention layer parameters are initialized to cause a value of each of the intermediate attention scores to be zero.

18. The method of claim 1, wherein prior to training of the neural network, the values of the regularized attention layer parameters are initialized to encourage a value of each of the intermediate attention scores to be near zero.

19. (canceled)

20. (canceled)

21. (canceled)

22. (canceled)

23. (canceled)

24. (canceled)

25. A system comprising:
one or more computers; and
one or more storage devices communicatively coupled to the one or more computers, wherein the one or more storage devices store instructions that, when executed by the one or more computers, cause the one or more computers to perform operations comprising:
receiving a network input;
processing the network input using a neural network that comprises a plurality of neural network layers arranged as a directed graph to generate a network output for the network input,
wherein the plurality of neural network layers comprise one or more regularized attention layers, and
wherein processing the network input comprises, for each regularized attention layer:
receiving a layer input to the regularized attention layer, wherein the layer input to the regularized attention layer comprises a set of input embeddings; and
applying a regularized attention operation over the set of input embeddings to generate a set of output embeddings, comprising:
processing the set of input embeddings, in accordance with values of a set of regularized attention layer parameters, to generate: (i) a set of value embeddings, comprising a respective value embedding for each input embedding, and (ii) a set of intermediate attention scores;
transforming the intermediate attention scores using a set of shaping constants to generate a set of transformed attention scores, wherein:
values of the shaping constants are initialized prior to training of the neural network and are not adjusted during the training of the neural network; and
the values of the shaping constants are selected to regularize the set of output embeddings; and
generating the set of output embeddings using: (i) the set of value embeddings, and (ii) the set of transformed attention scores; and
providing a layer output for the attention layer based on the set of output embeddings.

26. One or more non-transitory computer storage media storing instructions that when executed by one or more computers cause the one or more computers to perform operations comprising:
receiving a network input;
processing the network input using a neural network that comprises a plurality of neural network layers arranged as a directed graph to generate a network output for the network input,
wherein the plurality of neural network layers comprise one or more regularized attention layers, and
wherein processing the network input comprises, for each regularized attention layer:
receiving a layer input to the regularized attention layer, wherein the layer input to the regularized attention layer comprises a set of input embeddings; and
applying a regularized attention operation over the set of input embeddings to generate a set of output embeddings, comprising:
processing the set of input embeddings, in accordance with values of a set of regularized attention layer parameters, to generate: (i) a set of value embeddings, comprising a respective value embedding for each input embedding, and (ii) a set of intermediate attention scores;
transforming the intermediate attention scores using a set of shaping constants to generate a set of transformed attention scores, wherein:
values of the shaping constants are initialized prior to training of the neural network and are not adjusted during the training of the neural network; and
the values of the shaping constants are selected to regularize the set of output embeddings; and
generating the set of output embeddings using: (i) the set of value embeddings, and (ii) the set of transformed attention scores; and
providing a layer output for the attention layer based on the set of output embeddings.
